(19) United States
(12) Patent Application Publication
(10) Pub. No.: US 2018/0236477 A1
(43) Pub. Date: Aug. 23, 2018

(54) Debris Resistant Sprinkler

(71) Applicant: Rain Bird Corporation, Azusa, CA (US)

(72) Inventors: Michael A. McAfee, Tucson, AZ (US); William Tomas Phillips, Tucson, AZ (US)

(21) Appl. No.: 15/902,827

(22) Filed: Feb. 22, 2018

Related U.S. Application Data
(60) Provisional application No. 62/462,202, filed on Feb. 22, 2017.

(51) Int. Cl. B05B 15/555; B05B 15/74

(52) U.S. Cl. CPC B05B 15/555; A01G 25/02; B05B 15/74

(57) ABSTRACT

There is provided a pop-up sprinkler with improved flushing to resist debris build up that can cause improper pop-up and retraction operation. The stem of the sprinkler defines at least one path to flush debris from the sealing area between the stem and the housing of the sprinkler. This path can flush debris during pop-up of the stem from the housing and retraction of the stem into the housing. One or more grooves can be used to provide a number of flushing paths. The stem also can be tapered to provide additional flushing.

### CROSS REFERENCE TO RELATED APPLICATION

This application claims the benefit of U.S. Provisional Application No. 62/462,202, filed Feb. 22, 2017, which is incorporated by reference herein in its entirety.

### FIELD

The subject matter of this application relates to sprinklers and, more particularly, to a debris resistant pop-up sprinkler.

### BACKGROUND

Irrigation systems use emission devices to distribute water. One type of emission device is a pop-up sprinkler. A conventional pop-up sprinkler includes a housing and a stem. The stem extends from the housing during irrigation cycles and is retracted into the housing by a spring during the periods between irrigation cycles. A nozzle is mounted to the terminal end of stem for emitting water. The stem reciprocates between the extended and retraced position through a hole in a cap attached to the top of the housing. A seal resides at the hole of the cap to seal against the reciprocating stem.

One shortcoming with pop-up sprinklers is stickups caused by certain soil conditions, such as those with fine sand. A stickup is where the stem does not retract entirely at the conclusion of an irrigation cycle because debris becomes trapped between the inner diameter of the cap seal and the outer diameter of the stem. When a stem is stuck up, the pop-up sprinkler is more prone to damage, abuse, and is not aesthetically pleasing. Debris in this area also can prevent the stem from extending fully or at all during an irrigation cycle. Further, debris can damage the outside surface of the stem impeding the ability for the sprinkler to seal properly. The lack of an adequate seal can cause leakage during an irrigation cycle, which can lead to unnecessary water emission and an undesired pressure drop in the irrigation system.

There have been a number of attempts to address this shortcoming. One attempt uses a wiper at the seal. It has been found that this attempt does not work adequately for fine soil conditions such as sand. Another attempt uses stronger retraction springs. The downside of strong retraction springs is that they require a higher water pressure to extend the stem, which does not allow the sprinkler to be used at lower pressures, such as 15 psi.

Another attempt uses a tapered stem to allow bypass flow (flow that does not go through the nozzle) between the stem and the seal to flush out debris trapped in this area. While flushing is effective, it is believed that past designs have suffered from too much flushing, thereby negatively affecting the overall pressure in the irrigation system. More specifically, if during pop-up, the total flow for all sprinklers on a zone exceeds the design flow (using just the nozzle flow for each sprinkler) by a large amount, the system pressure can drop resulting in only a partial pop-up condition for one or more of the pop-up sprinklers.

Therefore, there remains a need for a solution where the bypass flow or flushing can occur just for a brief moment of time to clear debris without affecting the proper performance of the irrigation system.

### BRIEF DESCRIPTION OF THE DRAWINGS

FIG. 1 is a perspective view of a pop-up sprinkler embodying features of the present invention;

FIG. 2 is a centrally, longitudinal cross-sectional view of the pop-up sprinkler of FIG. 1 in a retracted state;

FIG. 3 is a centrally, longitudinal cross-sectional view of the pop-up sprinkler of FIG. 1 in a flushing state;

FIG. 4 is a centrally, longitudinal cross-sectional view of the pop-up sprinkler of FIG. 1 in an extended state;

FIG. 5 is a perspective view of a stem of the pop-up sprinkler of FIG. 1;

FIG. 6 is a perspective view of a guide and clutch ring of the pop-up sprinkler of FIG. 1;

FIG. 7 is a partial cut away of pop-up sprinkler of FIG. 1;

FIG. 8 is a cross-sectional view of a groove of the stem of FIG. 5; and

FIG. 9 is a perspective view of the pop-up sprinkler of FIG. 1 with a flush plug instead of a nozzle.

### DETAILED DESCRIPTION

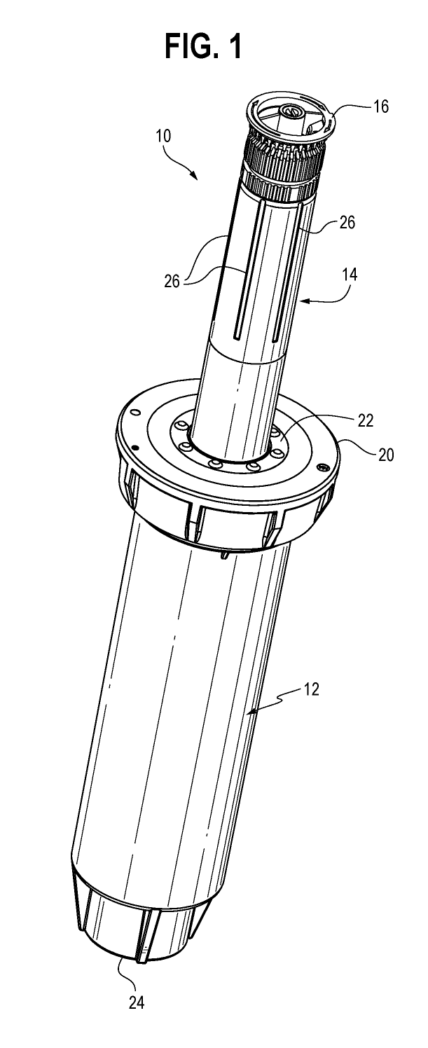

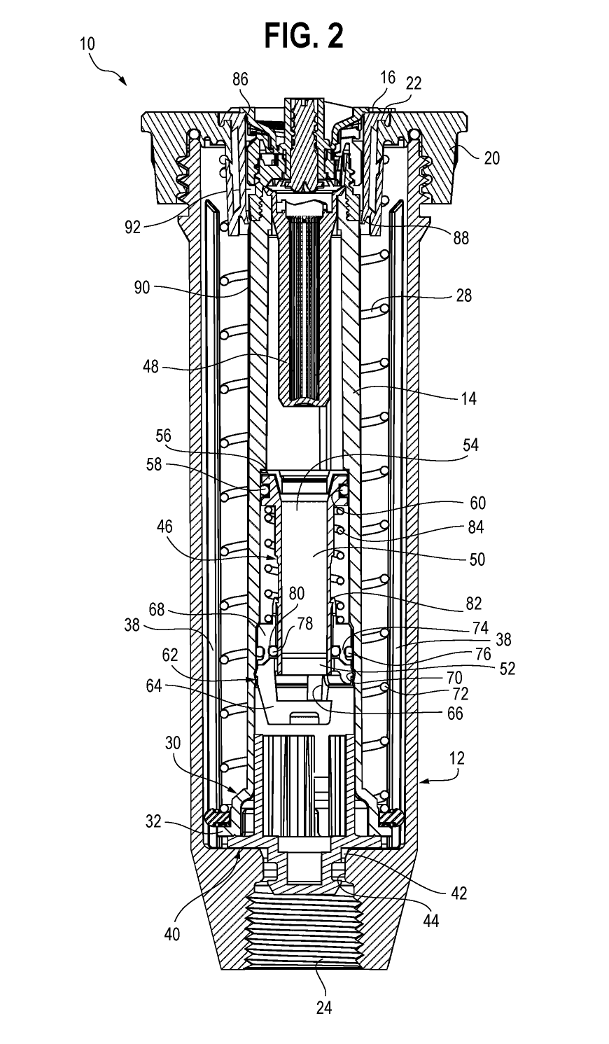

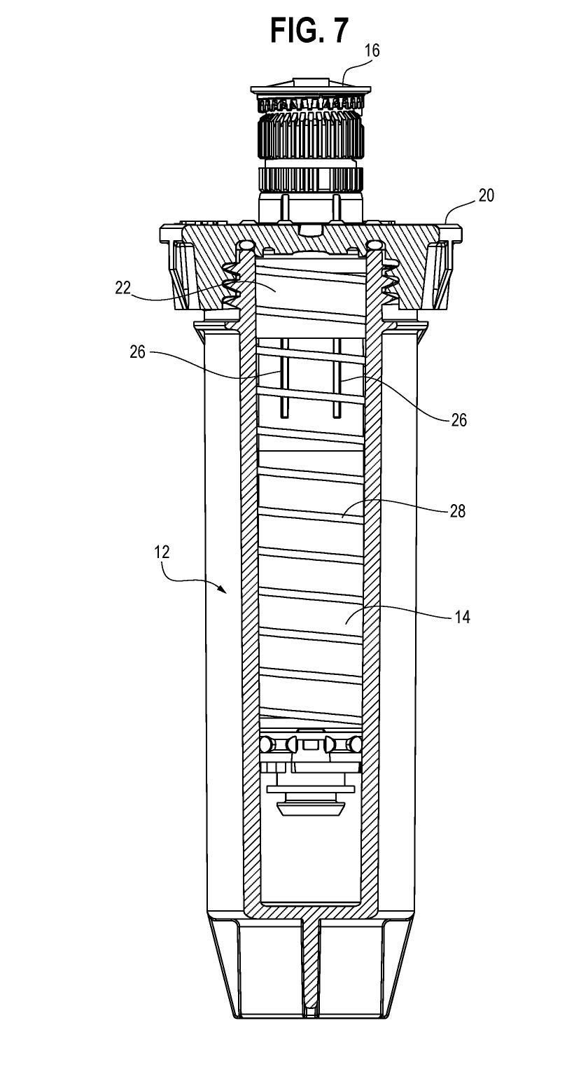

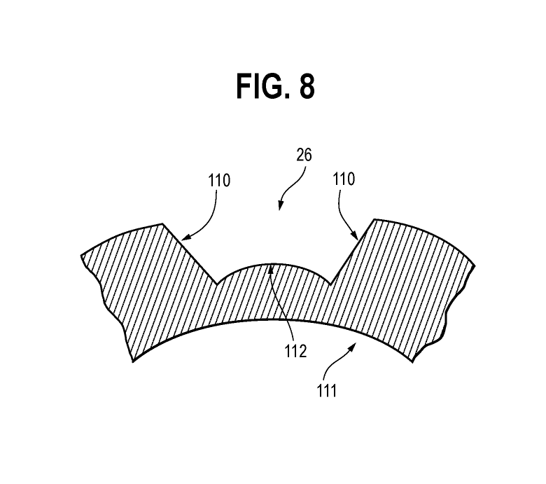

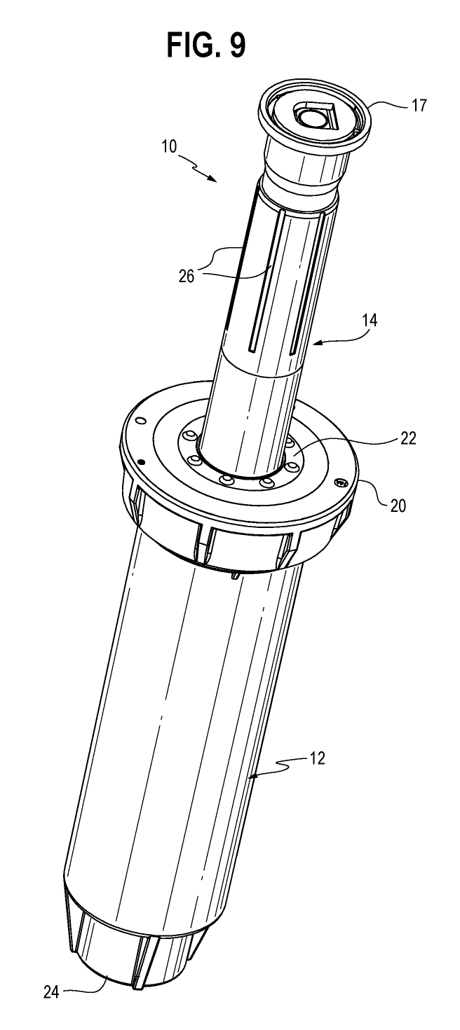

Referring to FIG. 1, there is illustrated a pop-up sprinkler 10 with a housing 12 and a stem 14 that reciprocates between an extended state (FIG. 1) and a retracted state (FIG. 2). The stem 14 includes a nozzle 16 for emitting water for irrigation. A flush cap 17 may be used in place of the nozzle (FIG. 9). The housing 12 includes a cover 20 and a seal 22 between the cover 20 and the stem 14 at one end and an inlet 24 opposite the cover 20 for attaching to an irrigation piping system. The stem 14 includes a series of longitudinally extending grooves 26. The grooves 26 assist in flushing debris from an area between the stem 14 and the seal 22. During flushing, the grooves 26 extend from inside the housing 12 to outside the housing 12 (FIG. 7). Debris is flushed through the grooves 26 past the seal 22. The flushing state occurs upon extension of the stem 14 at the start of an irrigation cycle and during retraction of the stem 14 at the conclusion of an irrigation cycle.

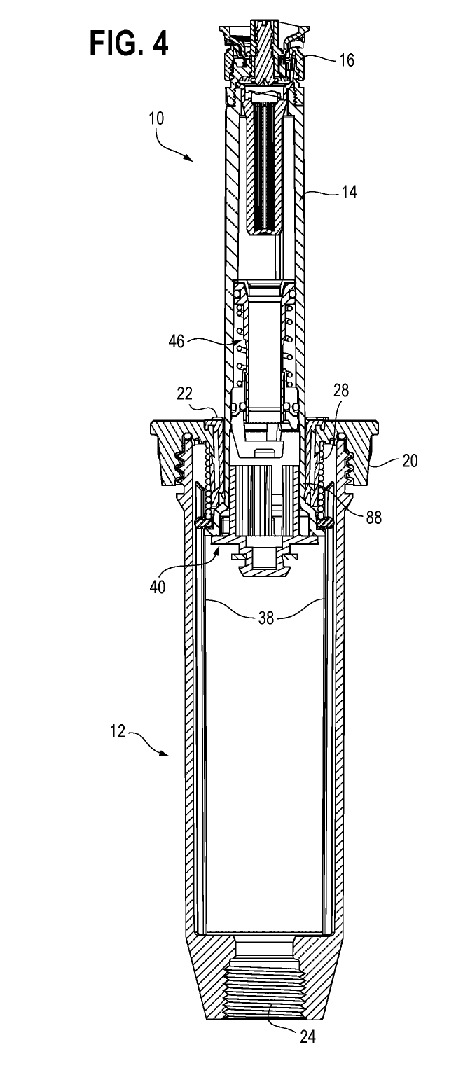

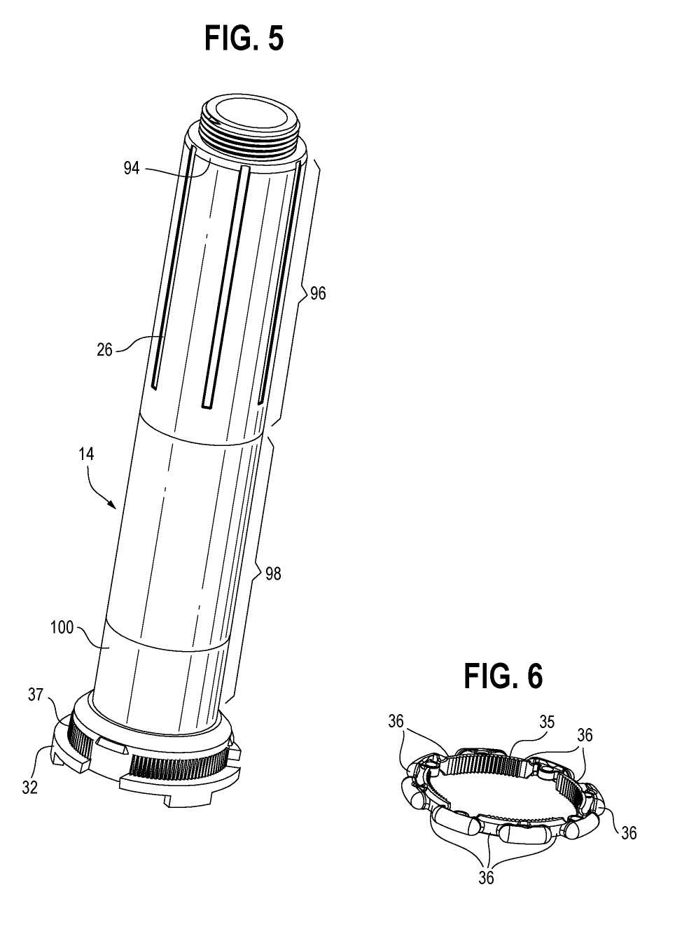

With reference to FIG. 2, the pop-up sprinkler 10 is shown in the retracted state. A helical spring 28 biases the stem 14 to the retracted state. In this state, there is insufficient water pressure in the irrigation system to move the stem 14 against the bias of the spring 28 to an extended state. The spring 28 resides in the housing 12 and about the stem 14. The spring 28 extends between a base 30 of the stem 14 and an inside surface of the cover 20. The base 30 includes an enlarged flange 32. A guide and clutch ring 34 is biased in place on the flange 32 by the spring 28 (FIG. 6). The outer portion of the ring 34 includes gaps 36 (FIG. 6) that ride along a number of longitudinally extending ribs 38 in the housing 12 (FIG. 4) that guide reciprocation of the stem 14 so that it does not unintentionally rotate during operation. The ring 34 and the stem 14 have serrations 35, 37, respectively, (FIGS. 5 and 6) that form a serrated engagement that allows a user to turn the stem 14 to set an edge of an irrigation pattern of water emitted from the nozzle 16.

A check valve 40 is attached to an underside of the flange 32 of the base 30. The check valve 40 includes a seal 42 that seals against an inner surface 44 of the inlet 24 when the stem 14 is in the retracted state. This sealing prevents water from draining out of the irrigation system through the pop-up sprinklers between irrigation cycles. The trapping of water in the irrigation system between irrigation cycles also reduces wear on the irrigation system by minimizing water hammer during start-up of an irrigation cycle.

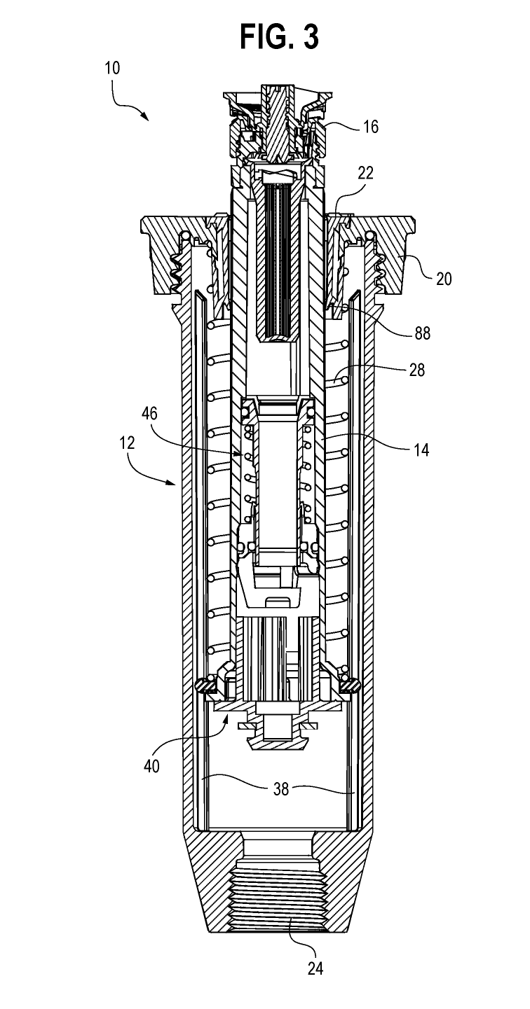

With reference to FIG. 3, a pressure regulator 46 is located in the stem 14 downstream of the check valve 40. More specifically, the pressure regulator 46 is mounted within a lower portion of the stem 14 above the base 30 and below a filter screen 48 of the nozzle 16. The pressure regulator 46 includes an elongated, hollow flow tube 50 mounted for limited longitudinal movement within the stem 14. The flow tube 50 has a circular cross-section with an open lower end 52 and an open upper end 54. The upper end 54 has a radially extending flange 56 dimensioned to be slidably received within the stem. An o-ring seal 58 is disposed within an outwardly open groove 60 formed about the flange 56. The o-ring provides a water tight seal between the flange 56 and the inside of the stem 14.

Secured within the stem 14 below the lower end 52 of the flow tube 50 is a flow seat 62. The flow seat 62 cooperates with the flow tube 50 to restrict the flow of water from the housing inlet 24 to the nozzle 16. The flow seat 62 can be generally cup shaped and has a closed bottom wall 64 from which upwardly project support posts 66 extending to an enlarged diameter ring portion 68 dimensioned to be received within the inside of the stem 14 and to surround the lower end 52 of the flow tube 50. Water flows from the inlet 24 between the posts 66 and into the flow tube 60. The flow seat 62 is secured within the stem 14 by an outwardly projecting circumferential bead or flange 70 received within a corresponding circumferential recess 72 formed about the inside of the stem 14.

To seal the flow seat 62 with respect to the stem 14, a retainer ring 82 is secured over the upper end of the ring portion 68, and an o-ring seal 76 is disposed within an outwardly open groove 74 of the ring portion 68 in sealing relation with the inside of the stem 14. A second o-ring seal 78 is disposed in a recess 80 formed by the ring portion 68 and the inside surface of the ring portion 68. The second o-ring seal 78 slidably and sealingly engages the outer wall of the flow tube 60 above its lower end 52.

The retainer ring 82 also functions as support for the lower end of a helical control spring 84 disposed within the stem 14 and surrounding the flow tube 50. The upper end of the spring 84 seats against a downwardly facing shoulder of the flange 56. The spring 84 operates to control movement of the flow tube 50 with respect to the stem 14 in response to water pressure within the stem 14.

More specifically, the pressure regulator 46 controls the pressure of water supplied to the nozzle 16 by controlling movement of the flow tube 50 against the bias of the control spring 84 in response to backpressure of water acting on the flange 56 on the downstream side of the pressure regulator 46. As water under pressure is supplied to the nozzle 16 through the stem 14, back pressure upstream of the nozzle 16 builds due to the constriction of the nozzle 16. Back pressure upstream of the nozzle 16 acts against the unsealed upper face of the flange 56 of the flow tube 50 and against the bias of the control spring 84. The area of the flange 56 has a larger area than the downwardly facing lower end of the flow tube 50, thereby creating a force differential tending to urge the flow tube 50 downwardly against the bias of the control spring 84. A further discussion of the pressure regulator can be found in U.S. Pat. No. 4,913,352, which is incorporated by reference herein.

The cover 20 threads onto the housing 12. The cover 20 includes a central hole 86. The seal 22 can be over-molded to the cover 20 at the central hole 86. The seal 22 extends below the cover 20 and includes an inward and upstream directed annular sealing rib 88. The sealing rib 88 engages an outer surface 90 of the stem 14 when the stem is in the fully extended state to seal the housing 12. The sealing rib 88 deflects radially inward further when under water pressure due to its inward and upstream directed configuration. The deflection could be about 0.003 inches. This helps place additional sealing pressure on the stem 14 when in the fully extended state. Otherwise, there may be a small clearance or light engagement due to the water pressure between the sealing rib 88 and the stem 14 while transitioning between the extended and the retracted states.

An area 92 between the stem 14 and the seal 22 tends to accumulate debris. Debris can be drawn into this area 92 from outside the pop-up sprinkler 10. Debris in this area 92 can affect the pop-up and retraction operation of the stem 14. For example, debris trapped in the area 92 can create excess friction such that the spring 28 cannot retract or fully retract the stem 14 into the housing 12. Debris also can cause a partial pop-up due to the excess friction. So, it is desired to be able to flush this area 92 during operation.

The grooves 26 extending longitudinally along the stem 14 assist to flush debris from the area 92. If debris enters the area 92 between the stem 14 and the seal 22, the grooves 26 provide a place for the debris to go which helps to prevent a lock up or stickup caused by increased friction from the debris. By providing a place for debris, the grooves 26 also reduce the potential for damage to the sealing surfaces between the stem 14 and the seal 22. In addition, the grooves 26 create pathways between the sealing rib 88 and the stem 14 where water driven by pressure during pop-up and retraction of the pop-up sprinkler 10 can accelerate to flush debris.

The length of the grooves 26 should be long enough to extend from inside the housing to outside the housing during pop-up and retraction (FIG. 7). The upper portion of the stem 14 can include an annular chamfered surface 94 (FIG. 5). The grooves 26 can extend through the chamfered surface 94.

The amount of flushing can be controlled by the length, width and depth of the grooves 26. For example, the grooves 26 can be extended or made wider or deeper to create more flushing during pop-up. FIG. 8 shows a cross-section perspective of the stem 14, wherein the grooves 26 can have walls 110 outwardly expanding radially from a center axis 111 extending longitudinally through the center of the stem 14. The grooves 26 could take on other cross-sections including triangular or rectangular. The grooves 26 can have a curved, arcuate base 112, or alternatively, the base may be flat. Exemplary dimensions for a groove with outwardly expanding walls 110 could be 0.05 inches in maximum wide, 0.05 inches in maximum depth and 1.6 inches in length. The depth of the walls 110 may be constant along the stem 14, or alternatively, the depth of the walls 110 can vary along the length of the stem 14.

Grooves with too large of a cross-section may back fill with debris, impeding pop-up or retraction of the stem 14 or may damage the stem which could affect pop-up and retraction. Furthermore, grooves that are too long can negatively affect pressure in the system, since the bypass passage will be in operation longer which may cause the water pressure in the system to drop to a level that impedes some or all of the stems of the sprinklers from extending fully or extending at all. It is believed that grooves with a length of 10-66% of the length of the stem 14 can provide flushing without impeding the pop-up performance of the sprinklers in the system. This could depend, however, on the overall pressure of the system during an irrigation cycle.

In the illustrated embodiment, there are six grooves 26 equally spaced around the stem 14. The number of grooves can also affect the amount of flushing. To increase flushing, the number of grooves can be increased but should not be increased to an amount where there is an undesired pressure loss to the system. The bypass flow can be limited generally to along the lengths of the grooves. The grooves can provide flushing for a brief moment of time during pop-up extension and retraction. This aids in controlling the use of the water pressure in the system so that the water pressure does not drop to a level where the stems are not popping-up entirely or at all. A typical pop-up pressure is 10-15 psi.

In addition to the flushing grooves 26, the stem 14 also can be tapered. The stem can have a constant taper along its length. Alternatively, the stem can have different taper segments. More specifically, the stem can be segmented into an upper portion 96, and a lower portion 98. The grooves 26 can be located along the upper portion 96. The upper and lower portions 96, 98 can be tapered at different rates. The upper portion can taper at a faster rate than the lower portion. For example, the lower portion could taper from about 0.7915 inches at the base of the stem to about 0.788 inches at the center of the stem, and the upper portion could taper from about 0.788 inches at the center of the stem to about 0.780 near the top of the stem.

The upper portion 96 can be a primary flush zone of the stem 14 during pop-up extension and retraction. The lower portion 98 can be a no flush zone. If the stem 14 is tapered aggressively, more debris can enter between the stem 14 and the seal 22 because of the increased clearance. With the flushing grooves 26, a less aggressive taper can be used for the stem 14. FIGS. 3 and 7 show the stem 14 when the primary flush zone is partially extending out of the housing 12. In this state, flushing can take place through the grooves 26. FIG. 4 shows the stem 14 in the fully extended state when the no flush zone is at the seal 22. When in this state, there should be no leakage at the seal 22.

A portion of the lower portion 98 adjacent the base 30 can be over-molded with a seal 100. The lower portion is not tapered and seals with the annular sealing rib 88 of the seal 22 when the stem 14 is fully extended during an irrigation cycle, and can be considered the sealing zone of the stem 14.

The grooves 26 further provide an enhanced gripping surface for manually rotating the stem 14 to set the edge of the nozzle spray pattern. The stem also could be textured to provide an enhanced gripping surface.

The above embodiment has been described with a stem with an upper portion 96 and lower portion 98, wherein each segment is tapered at different rates. Alternatively, the stem 14 can be segmented differently, such that the transition point between segments is not at the center of the stem 14, rather the upper portion 98 may be longer and the lower portion 98 equivalently shorter, and vice versa. Furthermore, the rate of tapering can be more aggressive at the upper portion 96, resulting in increased flushing. Additionally, the stem 14 may be tapered in any of the above described examples. Also, the stem may not include grooves and provide appropriate flushing through the upper portion and lower portion being tapered at different rates as described above.

The above embodiment has been described with a pressure regulator and a check valve. The grooves, however, can be used on the same embodiment but without the pressure regulator and/or the check valve. Further, grooves can be employed on any sprinkler having a pop-up stem, such as rotors.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. A sprinkler comprising:
a housing having an inlet connectable to an irrigation system;
a stem associated with the housing, the stem capable of being extended from the housing during an irrigation cycle and being retracted into the housing between irrigation cycles; and
at least one groove along at least a portion of the stem, the at least one groove providing a flushing path for water from the housing upon extension of the stem from the housing.

2. The sprinkler of claim 1 wherein the at least one groove provides a flushing path for water from the housing upon retraction of the stem into the housing.

3. The sprinkler of claim 1 further comprising a cover for the housing, the cover defining a hole through which the stem reciprocates when extending from the housing during an irrigation cycle and retracting into the housing between irrigation cycles.

4. The sprinkler of claim 3 further comprising an annular seal at the hole, and the flushing path enabling water to pass by the annular seal.

5. The sprinkler of claim 4 wherein the annular seal comprises an annular sealing rib that engages the stem to seal the housing when the stem extends from the housing during an irrigation cycle.

6. The sprinkler of claim 1 wherein the stem is tapered along at least a portion of its length.

7. The sprinkler of claim 6 wherein the stem has at least two different tapered segments, each tapered segment having a different taper rate.

8. The sprinkler of claim 7 further comprising a nozzle attached to the stem and wherein the taper rate is greater for the tapered segment adjacent the nozzle.

9. The sprinkler of claim 1 wherein the at least one groove along the stem comprises a plurality of grooves extending along at least a portion of the stem.

10. The sprinkler of claim 1 wherein the at least one groove comprises an outward expanding cross-section in a radial direction from a center axis.

11. The sprinkler of claim 10 wherein the at least one groove has a curved base.

12. The sprinkler of claim 1 wherein the at least one groove has a length sufficient to extend from inside the housing to outside the housing when the stem transitions from a retracted state in the housing to an extended state outside the housing.

13. A stem for a sprinkler comprising:
a stem body having a hollow interior for conveying water to a nozzle attachment end and an exterior; and
at least one groove extending along at least a portion of the exterior of the stem.

14. The stem of claim 13 wherein the stem body is tapered along at least a portion of its length.

15. The stem of claim 14 wherein the stem body has at least two different tapered segments, each tapered segment having a different taper rate.

16. The stem of claim 15 wherein the taper rate is greater for the tapered segment adjacent the nozzle attachment end.

17. The stem of claim 13 wherein the at least one groove comprises a plurality of grooves extending along at least a portion of the stem.

18. The stem of claim 13 wherein the at least one groove comprises a rectangular cross-section.

19. The stem of claim 13 wherein the stem body has a predetermined length and the at least one groove extends along at least 10 percent of the predetermined length of the stem body.

20. The stem of claim 13 wherein the stem body includes an annular chamfer adjacent the nozzle attachment end and the at least one groove extends through the annular chamfer.

21. The stem of claim 13 wherein the at least one groove comprises an outward expanding cross-section in a radial direction from a center axis of the stem body.

22. A sprinkler comprising:
a housing having an inlet connectable to an irrigation system;
a stem associated with the housing, the stem capable of being extended from the housing during an irrigation cycle and being retracted into the housing between irrigation cycles, the stem being tapered along at least a portion of its length, and the stem having two different tapered segments, each tapered segment having a different taper rate.

23. The sprinkler of claim 22 further comprising a nozzle attached to the stem and wherein the taper rate is greater for the tapered segment adjacent the nozzle.
